(19) United States
(12) Patent Application Publication
(10) Pub. No.: US 2014/0313199 A1
(43) Pub. Date: Oct. 23, 2014

(54) IMAGE PROCESSING DEVICE, 3D IMAGE DISPLAY APPARATUS, METHOD OF IMAGE PROCESSING AND COMPUTER-READABLE MEDIUM

(71) Applicant: KABUSHIKI KAISHA TOSHIBA, Tokyo (JP)

(72) Inventors: Norihiro NAKAMURA, Kawasaki-shi (JP); Yoshiyuki KOKOJIMA, Yokohama-shi (JP); Takeshi MITA, Yokohama-shi (JP)

(73) Assignee: KABUSHIKI KAISHA TOSHIBA, Tokyo (JP)

(21) Appl. No.: 14/184,617

(22) Filed: Feb. 19, 2014

(30) Foreign Application Priority Data
Apr. 23, 2013 (JP) 2013-090595

(51) Int. Cl. G06T 15/50

(52) U.S. Cl. CPC G06T 15/50
USPC 345/426

(57) ABSTRACT

A 3D image display apparatus according to embodiments is capable of displaying a 3D image. The apparatus may comprises a display, a quantization unit, a sub-pixel selector, a ray calculator, a brightness calculator, and a sub-pixel brightness generator. The display may have a display panel of which a plurality of sub-pixels are arranged on a surface and an optical aperture opposed to the display panel. The quantization unit may divide the surface of the display panel into areas. The selector may select one or more sub-pixels corresponding to each area to make a sub-pixel group. The ray calculator may calculate a ray number indicating a direction of a representative ray representing rays emitted from each sub-pixel group. The brightness calculator may calculate a brightness value corresponding to each ray number based on the direction of the representative ray and a model data figuring a 3D shape of an object. The sub-pixel brightness generator may generate the 3D image by determining a brightness value of the sub-pixels included in each sub-pixel group based on the brightness value.

### CROSS-REFERENCE TO RELATED APPLICATION(S)

This application is based upon and claims the benefit of priority from the Japanese Patent Application No. 2013-090595, filed on Apr. 23, 2013; the entire contents of which are incorporated herein by reference.

### FIELD

Embodiments described herein relate generally to an image processing device, a 3D image display apparatus, a method of image processing and a computer-readable medium.

### BACKGROUND

Conventionally, in a field of a medical diagnostic imaging system such as an x-ray CT (computed tomography) system, a MRI (magnetic resonance imaging) system, an ultrasonic diagnostics system, and so forth, an apparatus capable of generating a 3D medical image (volume data) is in practical use. Furthermore, in recent years, a technology of rendering a volume data from an arbitrary view point is in practical use, and a technique for rendering a volume data from a plurality of view points and sterically displaying the volume data on a 3D image display apparatus is under consideration.

In a 3D image display apparatus, a viewer can observe a 3D image with naked eyes without specific glasses. Such 3D image display apparatus displays multiple images with different view points (hereinafter each image will be referred to as a parallax image), and controls light rays of these parallax images by optical apertures (for instance, parallax barriers, lenticular lenses, or the like). At this time, pixels in the images to be displayed should be relocated so that a viewer viewing the images via the optical apertures from an intended direction can observe an intended image. Such method for relocating pixels may be referred to as a pixel mapping.

Light rays controlled by optical apertures and a pixel mapping complying with the optical apertures are drawn to both eyes of a viewer. Accordingly, when a position of the viewer is appropriate, the viewer can recognize a 3D image. A area where a viewer can view a 3D image is referred to as a visible range.

The number of view points for generating parallax images is previously decided, and generally, the number is short for determining brightness data of all pixels in a display panel. Therefore, regarding pixels which can not be determined from a target parallax image, brightness values are determined by using brightness data in the other parallax image having a view point closest to that of the target parallax image, by executing an linear interpolation based on brightness data of the other parallax image having a view point near that of the target parallax image, or the like.

However, because non-existent data are obtained by an interpolation process, the parallax image is blended with the other parallax image. As a result, a phenomenon such that edge in the image, which should be originally a single, is viewed two or more edges (hereinafter to be referred to as a multiple image), the whole image is blurred (hereinafter to be referred to a blurred image), or the like, may be occurred.

### BRIEF DESCRIPTION OF THE DRAWINGS

FIG. 1 is a block diagram showing a configuration example of a 3D image display apparatus according to a first embodiment;

FIG. 2 is a front view showing an example of an outline configuration of a display device according to the first embodiment;

FIG. 3 is an illustration showing a relationship between optical apertures and display elements of the display device according to the first embodiment;

FIG. 4 is an illustration for explaining a 3D pixel region according to the first embodiment;

FIG. 5 is an illustration showing a relationship between a quantized unit region and a sub-pixel group according to the first embodiment;

FIG. 6 is an illustration showing a relationship between a panel and reference view points when the reference view points are numbered from the very right in terms of ray number;

FIG. 7 is an illustration showing a relationship between sub-pixels belonging to a sub-pixel group and brightness values according to the first embodiment;

FIG. 8 is a flow chart showing an example of a whole operation of an image processing device according to the first embodiment;

FIG. 9 is a flow chart showing an example of a 3D image generating process according to the first embodiment;

FIG. 10 is an illustration showing a positional relationship between a rendering space and positions of an origin and a terminal of each representative ray in a horizontal direction according to the first embodiment;

FIG. 11 is an illustration showing a positional relationship between a rendering space and positions of an origin and a terminal of each representative ray in a vertical direction according to the first embodiment;

FIG. 12 is an illustration showing a positional relationship between a center of a panel and a reference point of a 3D pixel region according to the first embodiment;

FIG. 13 is an illustration for explaining a process of a brightness calculator according to an alternate example of the first embodiment;

FIGS. 14A to 14C are illustrations showing relationships between a panel and optical elements in optical apertures according to the second embodiment; and

FIG. 15 is a block diagram showing a configuration example of a 3D image display apparatus according to a second embodiment.

### DETAILED DESCRIPTION

Exemplary embodiments of an image processing device, a 3D image display apparatus, a method of image processing and a computer-readable medium will be explained below in detail with reference to the accompanying drawings.

### First Embodiment

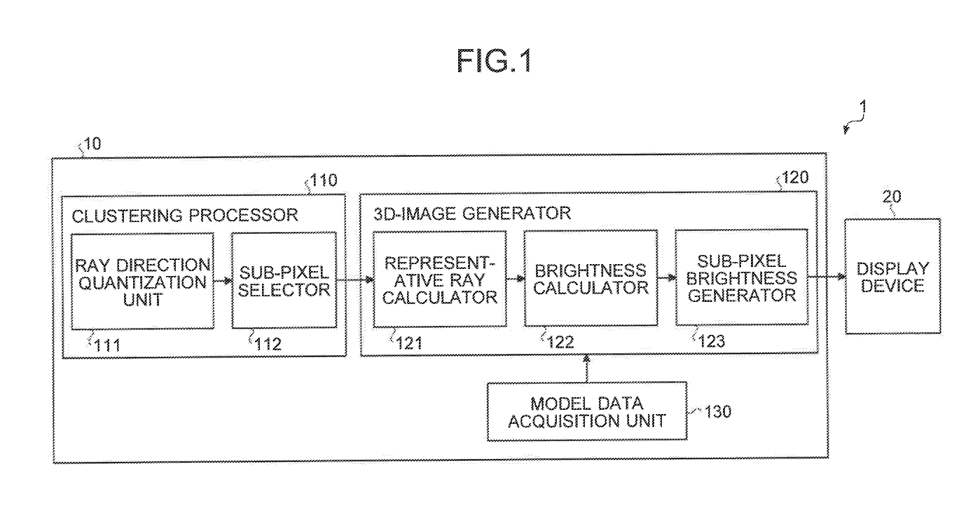

Firstly, an image processing device, a 3D image display apparatus, a method of image processing and a computer-readable medium according to a first embodiment will be described in detail with reference to the accompanying drawings. FIG. 1 is a block diagram showing a configuration example of a 3D image display apparatus according to the first embodiment. As shown in FIG. 1, the 3D image display apparatus 1 has an image processing device 10 and a display device 20. The image processing device 10 includes a clustering processor 110, a 3D image generator 120 and a model data acquisition unit 130.

The model data acquisition unit 130 can communicate with other devices directly or indirectly via a communication network. For example, the model data acquisition unit 130 acquires a medical image stored on a medical system, or the like, via the communication network. Any kind of network such as a LAN (local area network), the Internet©, or the like, for instance, can be applied to the communication network. The 3D image display apparatus 1 can be configured as a cloud system in which composing units are dispersively-located on a network.

The clustering processor 110 groups light rays with similar directions, each of which emitted from a sub-pixel and through an optical aperture. Specifically, the clustering processor 110 executes a process in which directions of light rays emitted from a certain range on a panel 21 previously-decided based on a division number are assumed as a single direction and sub-pixels belonging to this certain range (hereinafter to be referred to as a sub-pixel group) are grouped as a single group.

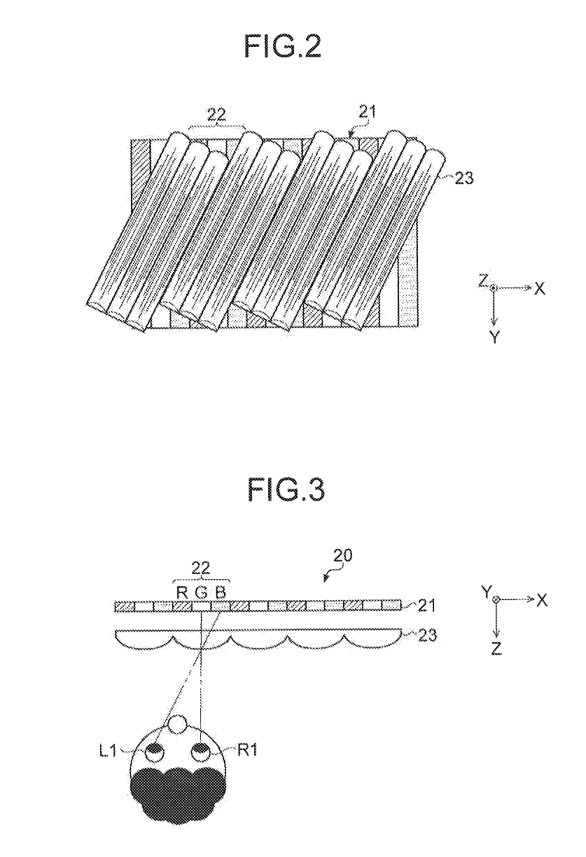

The clustering processor 110 includes a ray direction quantization unit 111 and a sub-pixel selector 112. The ray direction quantization unit 111 defines (zones) areas forming the sub-pixel groups on the panel 21 (see FIG. 2) in the display device 20 (hereinafter to be referred to as quantization unit area) based on a preset division number, and calculates parameters indicating each quantization unit area (hereinafter to be referred to as area parameters). To the ray direction quantization unit 111, parameters about location relationship, sizes, and so forth, of the panel 21 and an optical aperture 23 (hereinafter to be referred to as panel parameter) are inputted. The ray direction quantization unit 111 calculates the area parameters indicating the quantization unit areas using the panel parameters.

The sub-pixel selector 112 selects one or more sub-pixels belonging to each quantization unit area based on the area parameters calculated by the ray direction quantization unit 111, and groups the selected sub-pixels into sub-pixel groups.

The 3D image generator 120 calculates light rays (hereinafter to be referred to as representative ray) to be used for rendering, in which each sub-pixel group is used as a unit, based on ray numbers of the sub-pixel groups and information about the sub-pixel groups. Here, a ray number is information indicating which direction light emitted from a sub-pixel points via the optical aperture 23.

The 3D image generator 120 calculates a view point of each representative ray calculated for each sub-pixel group (hereinafter to be referred to as representative view point) based on locations of view positions with respect to a 3D-image displayed on the display device 20 and reference view points specifying projection amounts. Furthermore, the 3D image generator 120 obtains a brightness value of each sub-pixel group based on the representative view points and a model data figuring 3D shapes of objects, and generates a 3D image by assigning the obtained brightness value to each sub-pixel group.

The 3D image generator 120 includes a representative ray calculator 121, a brightness calculator 122 and a sub-pixel brightness generator 123. The representative ray calculator 121 calculates a direction of each representative ray (hereinafter to be referred to as representative ray direction) of each sub-pixel group. The brightness calculator 122 calculates information including a starting position and a terminal position of each representative ray and/or a directional vector of each representative ray (hereinafter to be referred to as representative ray information) based on each representative ray direction, and calculates a brightness value of each sub-pixel group based on the model data and each representative ray information. The sub-pixel brightness generator 123 calculates a brightness value of each sub-pixel in each sub-pixel group based on the calculated brightness value of each sub-pixel group, and inputs a 3D image constructed from an array of the calculated brightness values of the sub-pixels to the display device 20.

The display device 20 has the panel 21 and the optical aperture 23 for displaying a 3D image, and displays the 3D image so that a user can view the displayed 3D image stereoscopically. The model data for explaining the first embodiment may be a 3D image data such as a volume data, a boundary representation model, or the like. The model data includes a volume data capable of using as a 3D medical image data.

Next, each unit (device) shown in FIG. 1 will be explained in more detail.

Display Device

FIG. 2 is a front view showing a configuration example of the display device shown in FIG. 1. FIG. 3 is an illustration showing a relationship between an optical aperture and a display element of the display device shown in FIG. 2. In the following explanation, a range where the user can view a 3D image displayed on the display device 20 stereoscopically will be called a visible range.

As shown in FIGS. 2 and 3, the display device 20 has, in a real space, a display element (hereinafter to be referred to as panel) 21 in which a plurality of pixels 22 are arrayed in a matrix in a plane, and the optical aperture 23 arranged in front of the panel 21. By observing the display element (panel) 21 via the optical aperture (also referred to as aperture controller) 23, a user can recognize a 3D image displayed on the display device 20. In the following explanation, a horizontal direction of the panel 21 is defined as X axis, and a normal direction of a front face of the panel 21 is defined as Z axis. However, a coordinate system defined to the real space is not limited to such coordinate system.

The panel 21 displays a 3D image stereoscopically. As the panel 21, it is possible to use a direct-view-type 2D-display such as an organic EL (electro luminescence), a LCD (liquid crystal display), a PDP (plasma display panel), a projection display, or the like.

In each pixel 22, a group including one sub-pixel from each of the colors of RGB is considered as a single unit. Sub-pixels of each color of RGB included in the pixels 22 are arrayed along the X axis, for instance. However, such arrangement is not definite while it is also possible to have various arrangement where one pixel includes four sub-pixels of four colors, one pixel includes two sub-pixels of a blue component, for instance, among the colors of RGB, or the like, for example.

The optical aperture 23 directs a light ray emitted forward (−Z direction) from each pixel of the panel 21 to a predetermined direction via an aperture. As the optical aperture 23, it is possible to use an optical element such as a lenticular lens, a parallax barrier, or the like. For example, a lenticular lens has a structure such that fine and narrow cylindrical lenses are arrayed in a shorter direction (which is also called an array direction).

As shown in FIG. 3, a user locating inside a visible range of the display device 20 by observing via the optical aperture 23, views sub-pixels of G component among the pixels 22 of the panel 21 with a right eye R1 and sub-pixels of B component among the pixels 22 of the panel 21 with a left eye L1, for instance. Whereat, as shown in FIG. 2, the optical aperture 23 is structured so that a longer direction of each optical element constructing the optical aperture 23 (which is perpendicular to the array direction) is inclined with respect to the panel 21 (for instance, a direction of Y axis) by a predetermined angle (for instance, θ). The display device 20 can let a user view a 3D image stereoscopically by displaying a 3D image of which pixel values of the sub-pixels are calculated based on variations of ray directions occurred by the inclinations of the optical elements.

Model Data Acquisition Unit

The model data acquisition unit 130 acquires a model data from an external. The external is not limited to storage media such as a hard disk, a CD (compact disk), or the like, but it can also include a server, or the like, which is capable of communicating via a communication network.

As the server connected with the model data acquisition unit 130 via the communication network, a medical diagnostic imaging unit, or the like can be considered. The medical diagnostic imaging unit is a device capable of generating a 3D medical image data (volume data). As the medical diagnostic imaging unit, a X-ray diagnostic apparatus, a X-ray CT (computed tomography) scanner, a MRI (magnetic resonance imaging) machine, an ultrasonograph, a SPECT (single photon emission computed tomography) device, a PET (positron emission computed tomography) device, a SPECT-CT system which is integrated combination of a SPECT device and a X-ray CT scanner, a PET-CT system which is integrated combination of a PET device and a X-ray CT scanner, or a group of these devices can be used, for instance.

The medical diagnostic imaging unit generates a volume data by imaging a subject. For instance, the medical diagnostic imaging unit collects data such as projection data, MR signals, or the like, by imaging the subject, and generates volume data by reconstructing a plurality of sliced images (cross-section images), which may be 300 to 500 images, for instance, taken along a body axis of the subject. That is, the plurality of the sliced images taken along the body axis of the subject are the volume data. On the other hand, it is also possible to use projection data, MR signals, or the like, itself imaged by the medical diagnostic imaging unit as volume data. The volume data generated by the medical diagnostic imaging unit can include images of things (hereinafter to be referred to as object) being observation objects in medical practice such as bones, vessels, nerves, growths, or the like. Furthermore, the volume data can include data representing isopleth planes with a set of geometric elements such as polygons, curved surfaces, or the like.

Ray Direction Quantization Unit

The ray direction quantization unit 111 defines quantization unit areas forming sub-pixel groups on the panel 21 based on a preset division number. Specifically, the ray direction quantization unit 111 calculates a width Td of each area (quantization unit area), which is defined by dividing a 3D pixel region based on a division number Dn, in an X axis direction.

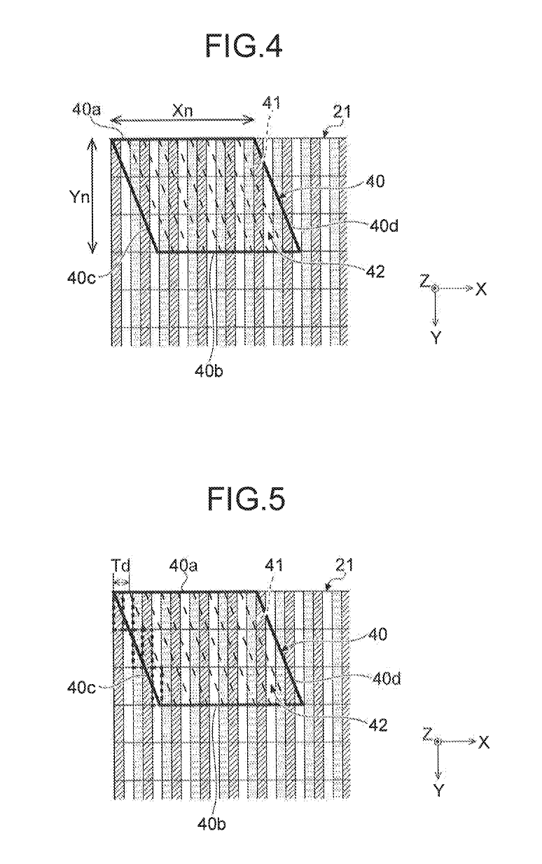

In the following, a 3D pixel region will be explained. FIG. 4 is an illustration for explaining a 3D pixel region. As shown in FIG. 4, a 30 pixel region 40 is a region having a horizontal width Xn and a vertical width Yn in an XY coordinate system defined by the X axis and the Y axis on the basis of the X axis with respect to the longer direction of the optical aperture 23; the horizontal width Xn being a length of a side along the X axis and the vertical width Yn being a length along the Y axis. Each 3D pixel region 40 is divided into Dn areas (quantization unit areas) so that dividing lines 41 for dividing the 3D pixel region 40 become parallel to the longer direction of each optical element of the optical aperture 23. When the division number Dn is eight, for instance, seven dividing lines 41 are defined. Each dividing line 41 is parallel to sides 40c and 40d of the 3D pixel region 40; each of the sides 40c and 40d having an axial component along the Y axis. Adjacent dividing lines 41 are arrayed at even intervals. An interval Td between the adjacent dividing lines 41 can be obtained as the following formula (1), for instance. Here, the interval Td is a length in the X axis direction.

$$Td = \frac{Xn}{Dn} \qquad ( 1 )$$

Each dividing line 41 maintains a certain distance from the side 40c of the 3D pixel region 40, of which X coordinate is smaller than that of the side 40d. This is the same for all the dividing lines 41. Therefore, directions of light rays of lights emitted from the dividing lines 41 will all be the same direction. In the first embodiment, each area 42, which one kind being surrounded by the sides 40c or 40d of the 3D pixel region 40, a dividing line 41 adjacent to the sides 40c or 40d and boundary lines of the 3D pixel region 40, which are parallel to the X axis (hereinafter to be referred to as an upper side 40a and a lower side 40b, respectively), and another one kind being surrounded by two dividing lines 41 adjacent to each other, an upper side 40a and a lower side 40b, is defined as a unit constructing a sub-pixel group, and will be called the quantization unit area.

As a result of defining the 3D pixel region, an area which made be insufficient for constructing a single 3D pixel region may remain at the left end or the right end of the panel 21. As for the remaining area, it is possible to deem that the remaining area is included in a laterally adjacent 3D pixel region 40. In such case, the expanded 3D pixel region 40 may be defined such that the expanded part (the remaining area) protrudes outside the panel 21, and it may be processed in the same way as the other 3D pixel regions 40. As another method, it is possible to assign a single color such as black, white, or the like, for the remaining area.

In FIG. 4, although the horizontal width Xn is the same as the width along the X axis of each optical element of the optical aperture 23, it is not limited to such arrangement. Furthermore, in the formula (1), although the interval Td is constant, the interval Td does not necessarily have to be constant. For example, it is also possible to arrange such that the closer to the upper side 40a or the lower side 40b of the 3D pixel region 40 the quantization unit area is, the larger the interval Td becomes, and the farther from the upper side 40a or the lower side 40b of the 3D pixel region 40 the quantization unit area is (that is, the closer to a center of the 3D pixel region 40 the quantization unit area is), the smaller the interval Td becomes.

In FIG. 4, although a case where an edge of the lens (or the barrier) constructing the optical aperture 23 corresponds to au upper left corner of the panel 21 is exemplified, there is a case where they are off from each other. In such case, a position where each 3D pixel region 40 is to be defined should be shifted by the same length. As for the remaining area that may be produced at the left end or the right end due to the position shifting of the 3D pixel region 40, it is possible to apply the method in which the adjacent 3D pixel region 40 is expanded, the method in which a single color is assigned to the remaining area which are the same as in the above-described process, or the like.

Sub-Pixel Selection Unit

The sub-pixel selector 112 selects one or more sub-pixels of which ray directions are deemed as the same direction based on each quantization unit area 42 defined by the ray direction quantization unit 111, and groups these sub-pixels into a single sub-pixel group. Specifically, as shown in FIG. 5, as for a certain quantization unit area 42, the sub-pixel selector 112 selects all sub-pixels of which representative points are included in the certain quantization unit area 42. Each representative point may be a predetermined position such as an upper left, a center, or the like, of each of the sub-pixel, for instance. In FIG. 5, a case where the representative point is defined as the upper left of each sub-pixel is exemplified.

When the sub-pixel selector 112 selects the sub-pixels, the sub-pixel selector 112 obtains X coordinates Xt of the side 40c of the certain quantization unit area 42 with respect to Y coordinates Yt belonging to a range of the vertical width Yn of the certain quantization unit area 42. All sub-pixels of which representative points are included within a range (Xt+Td) of the interval Td from the X coordinate Xt are target sub-pixels for grouping. Therefore, when the X coordinate Xt is defined by sub-pixel, for instance, integer values included in the range (Xt+Td) are X coordinates of selected sub-pixels. For example, when Xt is 1.2, Td is 2 and Yt is 3, coordinates of selected sub-pixels are (2, 3) and (3, 3). By executing similar selecting for every Y coordinate Yt included within a range of a vertical width Yn, the sub-pixel selector 112 selects all sub-pixels of which representative points belong to the range for every quantization unit area, and defines the selected sub-pixels for each quantization unit area as a sub-pixel group for the corresponding quantization unit area.

Representative Ray Calculation Unit

The representative ray calculator 121 calculates a ray number of each sub-pixel belonging to each sub-pixel group. Furthermore, the representative ray calculator 121 calculates a representative ray number for every quantization unit area based on the ray numbers calculated for the sub-pixels, and calculates representative ray information based on the calculated representative ray number for every quantization unit area. Specifically, the representative ray calculator 121 calculates a ray number indicating a direction where a light ray emitted from each sub-pixel of the panel 21 travels via the optical aperture 23.

Here, each ray number is a direction indicated by a light ray emitted from each sub-pixel of the panel 21 via the optical aperture 23. For example, the ray numbers can be calculated by numbering in an order that a direction of light emitted from a position corresponding to the lower side 40c of each 3D pixel region 40 is numbered as ‘0’ and a direction of light emitted from a position distant from the side 40c by Xn/N is numbered as ‘1’ while the number of the reference view points is defined as N and the 3D pixel regions 40 (regions with the horizontal width Xn and the vertical width Yn) are zoned based on the X axis with respect to the longer direction of the optical aperture 23. For such numbering, it is possible to apply a method mentioned in a non-patent literature 1 of “image preparation for 3D-LCD” by C. V. Berkel, Proc. SPIE, Stereoscopic Displays and Virtual Reality Systems, vol. 3639, pp. 84-91, 1999, for instance.

Thereby, with respect to a light ray of light emitted from each sub-pixel, a number indicating a direction indicated by each light ray via the optical aperture 23 is given as a ray number. A plurality of preset reference view points may be arrayed on a line which meets in a line perpendicular to a vertical line passing through a center O of the panel 21 and is parallel to the X axis at even intervals, for instance.

When a width along the X axis of each optical element being a composition element of the optical aperture 23 does not correspond to the horizontal width Xn, the ray numbers indicating the directions of the light rays may be serial numbers only within the single 3D pixel region 40. That is, directions indicated by ray numbers of a certain 3D pixel region 40 may not be the same as directions indicated by the same ray numbers of another 3D pixel region 40. However, when the same ray numbers are grouped into a single set, light rays corresponding to ray numbers belonging to each set may be focused on a position differing from set to set (hereinafter to be referred to as focus point). That is, light rays focusing on the same point have the same ray numbers, and light rays belonging to a set of ray numbers different from the above ray numbers focus on the same focus point different from the above focus point.

On the other hand, when a width along the X axis of each optical element being a composition element of the optical aperture 23 corresponds to the horizontal width Xn, light rays having the same ray numbers becomes approximately parallel to each other. Therefore, light rays with the same ray numbers in all of the 3D pixel regions may indicate the same direction. Additionally, a focus point of the light rays corresponding to the ray numbers belonging to each set may be located on an infinite distance from the panel 21.

The reference view points are a plurality of view points, each of which may be called a camera in the field of computer graphics, defined at even intervals with respect to a space for rendering (hereinafter to be referred to as rendering space). As a method for arranging ray numbers to a plurality of the reference view points, it is possible to number the reference view points in order from rightmost under facing the panel 21. In such case, a ray number ‘0’ is arranged to a rightmost reference view point, and a ray number ‘1’ is arranged to a subsequent rightmost reference view point.

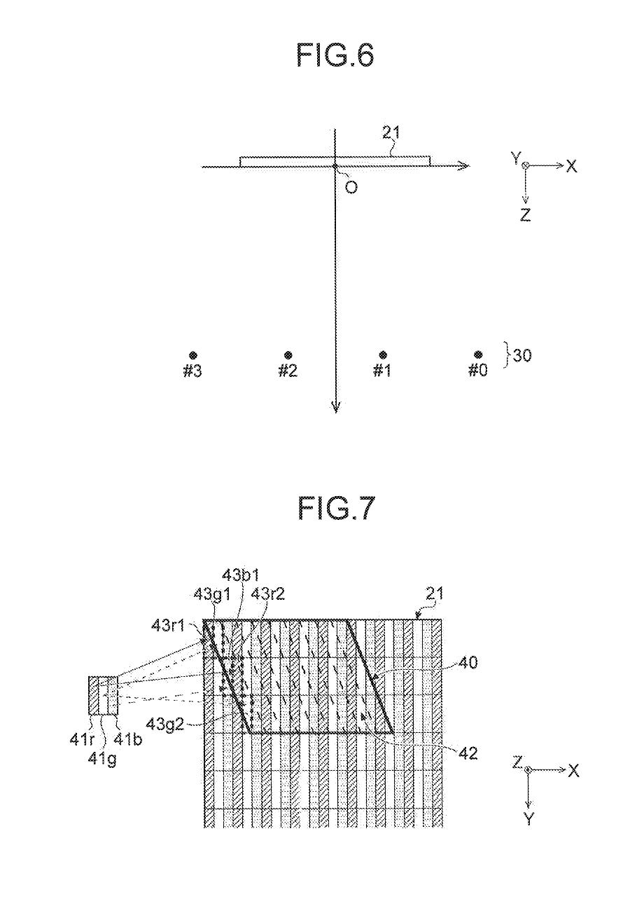

FIG. 6 is an illustration showing a relationship between a panel and reference view points when the reference view points are numbered in order from rightmost with respect to the panel. As shown in FIG. 6, when four reference view points 30 of #0 to #3 are arranged with respect to the panel 21, integral ray numbers ‘0’ to ‘3’ are arranged to the reference view points 30 in order from a rightmost reference view point #0. The wider the interval between adjacent reference view points 30 is, the larger the parallax becomes, and thereby, it is possible to display a more stereoscopic 3D image for a user. That is, by adjusting the intervals between the reference view points #0 to #3, it is possible to control a projection amount of the 3D image.

When ray numbers of n sub-pixels included in a sub-pixel group are numbered as v₁ to vₙ, respectively, a representative ray number v′ can be obtained by the following formula (2), for instance. In the formula (2), v1 to vn indicate ray numbers of sub-pixels belonging to a sub-pixel group, and n indicates the number of the sub-pixels belonging to the sub-pixel group.

$${v}^{′} = \frac{1}{n} {\sum }_{n} {v}_{n} \qquad ( 2 )$$

However, a method of calculating a representative ray number of each quantization unit area 42 is not limited to the method using the formula (2). It is also possible to use a various method such as a method of determining a representative ray number using a weighted average instead of using a simple average such as a median value of the ray numbers as the representative ray number as the method of using the formula (2), for instance. In the case of using the weighted average, the weighted average may be determined based on color of sub-pixels, for instance. In addition, because luminosity factor of G component is generally high, it is possible to increase weights for ray numbers of sub-pixels representing G component.

The representative ray number calculator 121 calculates a starting position and a terminal position of each representative ray and/or a directional vector of each representative ray based on the calculated representative ray numbers.

Brightness Calculation Unit

The brightness calculator 122 calculates a brightness value of each quantization unit area 42 based on the representative ray information of each of the quantization unit area 42 and the volume data. As a method of calculating brightness value, it is possible to use a technique such as the ray casting algorithm, the ray tracing algorithm, or the like, well-known in the field of computer graphics. The ray casting algorithm is a technique such that rendering is executed by integrating color information at crossing points of light rays and objects. The ray tracing algorithm is a technique of further considering reflection light in the ray casting algorithm.

Sub-Pixel Brightness Calculation Unit

The sub-pixel brightness generator 123 decides a brightness value of each sub-pixel included in the sub-pixel group corresponding to each quantization unit area 42 based on the brightness value calculated by the brightness calculator 122 for each quantization unit area 42. Specifically, as shown in FIG. 7, for each quantization unit area 42, the sub-pixel brightness generator 123 replaces values of sub-pixels 43r1, 43r2, 43g1, 43g2 and 43b1 in the sub-pixel group with color components 41r, 41g and 41b of the brightness value calculated by the brightness calculator 122. For example, when the sub-pixels 43g1 and 43g2 in the sup-pixel group represent G components, the G component 41g calculated by the brightness calculator 122 is applied to the G components of the sub-pixels 43g1 and 43g2.

The 3D image generator 120 generates a 3D image constructed from an array of the brightness values calculated thereby. The generated 3D image is inputted to the display device 20 and is displayed so that a user can view the displayed 3D image stereoscopically.

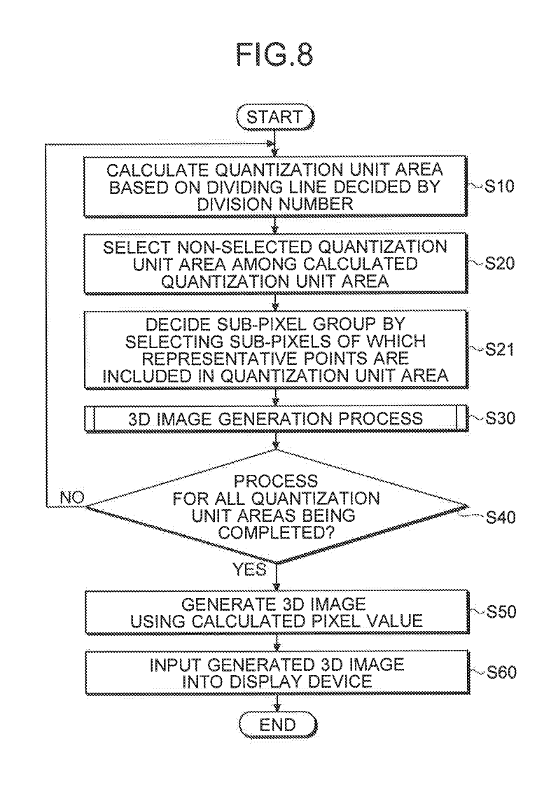

Next, an operation of the image processing device 10 will be described in detail with accompanying drawings. FIG. 8 is a flow chart showing an example of an outline operation of the image processing device 10. As shown in FIG. 8, in the operation, firstly, in the ray direction quantization unit 111, dividing lines 41 for a 3D pixel region 40 are calculated based on the preset division number, and quantization unit areas 42 are calculated based on the calculated dividing lines 41 (step S10). Here, a definition of the 3D pixel region 40 being a unit for calculation can be the same as described above.

Next, in the sub-pixel selector 112, an unselected quantization unit area 42 is selected from among the calculated quantization unit areas 42 (step S20). As a selection method of the quantization unit area 42, it is possible to use a various method such as the round-robin, or the like, for instance. Then, in the sub-pixel selector 112, all sub-pixels of which representative points are included in the selected quantization unit area 42 are selected, and a sub-pixel group is defined by grouping the selected sub-pixels (step S21).

Next, in the 3D image generator 120, a 3D image generation process of executing from calculation of representative ray information to calculation of brightness values of sub-pixels is executed (step S30).

After that, the image processing unit 10 determines whether the 3D image generation process of step S30 is executed for all the quantization unit areas 42 calculated in step S10 or not (step S40), and when unprocessed quantization unit area 42 is exists (step S40; NO), the image processing unit 10 returns to step S10 and repeats the above steps until all the quantization unit areas 42 have been processed by the 3D image generation process of step S30. On the other hand, when all the quantization unit areas 42 have been processed by the 3D image generation process of step S30 (step S40; YES), the image processing device 10 generates a 3D image using the calculated pixel values (step S50), inputs the generated 3D image to the display device 20 (step S60), and then, quits this operation.

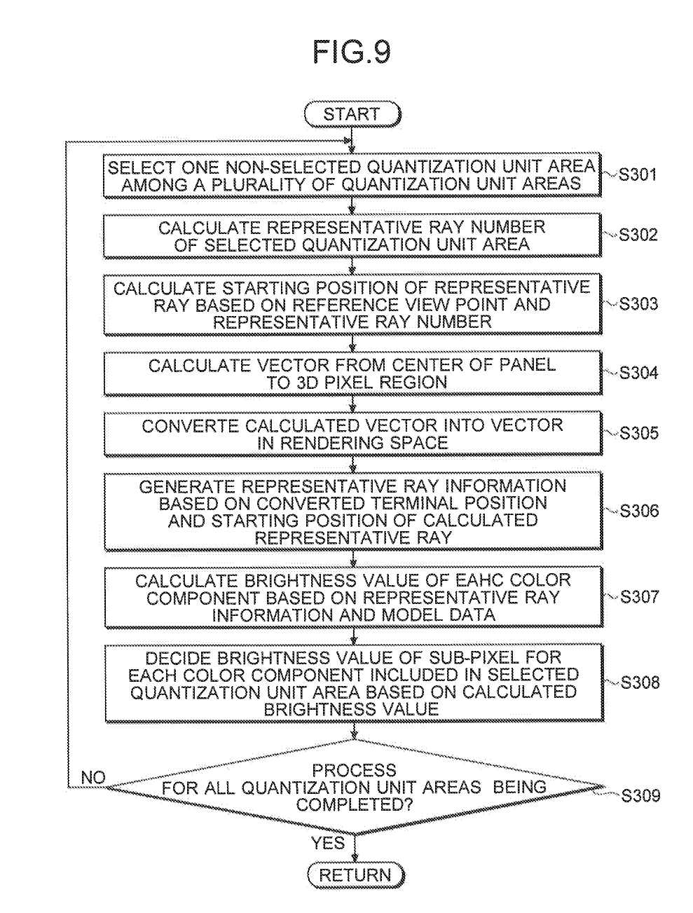

The 3D image generation process shown in step S30 in FIG. 8 will be described in detail with accompanying drawings. FIG. 9 is a flow chart showing an example of the 3D image generation process.

In the 3D image generation process, firstly, in the representative ray calculator 121, an unselected quantization unit area 42 is selected from among the plurality of the quantization unit areas 42 (step S301). As a selection method of the quantization unit area 42, it is possible to use a various method such as the round-robin, or the like, for instance. Then, in the representative ray calculator 121, a representative ray number of the selected quantization unit area 42 is calculated (step S302). A calculation method of the representative ray number can be the same as described above.

Next, in the representative ray calculator 121, representative ray information about a representative ray based on the calculated representative ray number is calculated. Specifically, firstly, a starting position (view point) of the representative ray with respect to the selected quantization unit area 42 is calculated based on the calculated representative ray number and preset positions of the reference view points 30 (step S303).

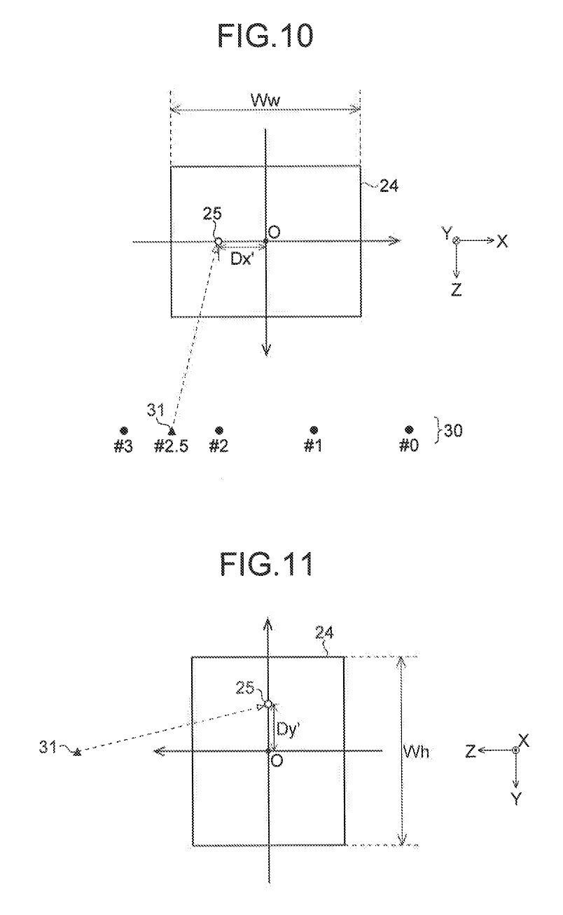

FIG. 10 shows a positional relationship in a horizontal direction (width direction of a rendering space) between a rendering space and a starting position and a terminal position of a representative ray. FIG. 11 shows a positional relationship in a vertical direction (height direction of the rendering space) between the rendering space and the starting position and the terminal position of the representative ray. In the following explanation, for the sake of shorthand, a case where a width Ww of the rendering space 24 corresponds to a width of the panel 21 and a height Wh of the rendering space 24 corresponds to a height of the panel 21 will be explained as an example. In such case, a center O of the panel 21 corresponds to a center O of the rendering space 24.

When the representative ray number calculated in step S 302 is an integer, in step S303, a position of a reference view point corresponding to the representative ray number can be used as a starting position of the representative ray in the horizontal direction (width direction of the panel 21). On the other hand, when the calculated representative ray number includes a digit after the decimal point, in step S303, a starting position corresponding to the representative ray number will be calculated by a linear interpolation based on positions of adjacent reference view points. As shown in FIG. 10, in a case where the representative ray number is calculated as ‘2.5’, a position of a view point 31 (representative view point #2.5) corresponding to the representative ray number ‘2,5’ is specified by a linear interpolation based on a position of a reference view point #2 corresponding to a ray number ‘2’ and a position of a reference view point #3 corresponding to a ray number ‘3’, and the specified position is defined as a starting position of a representative ray. Here, because the reference view points 30 may be arrayed on a line which meets in a line perpendicular to a vertical line passing through a center O of the panel 21 and is parallel to the X axis at even intervals, as shown in FIG. 11, the starting position of the representative ray in the vertical direction (height direction of the panel 21) does not shift.

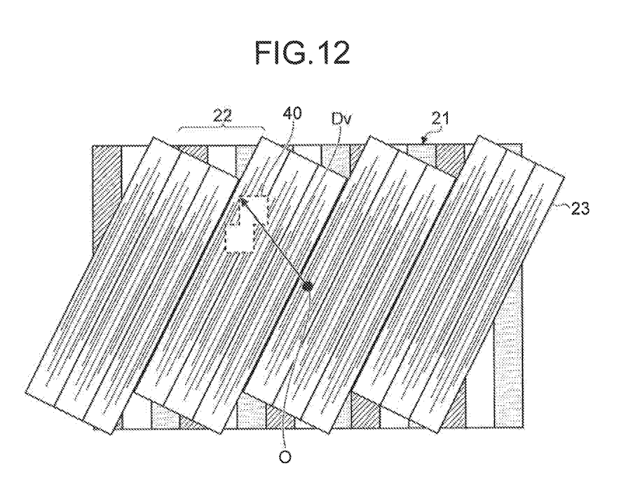

Next, in the representative ray calculator 121, vectors Dv=(Dx, Dy) from the center O of the panel 21 to reference points 25 preset with respect to each of the 3D pixel regions 40 are obtained (step S304). FIG. 12 is an illustration showing a positional relationship between a center of a panel and a reference point of a 3D pixel region. In the example shown in FIG. 12, the reference point 25 of the 3D pixel region 40 is arranged to an upper left corner of the 3D pixel region 40, for instance.

Next, in the representative ray calculator 121, the vector Dv calculated with respect to the panel 21 is converted a vector Dv′=(Dx′, Dy′) in the rendering space 24 (step S305). That is, in step S305, the vector Dv′=(Dx′, Dy′) indicating a position of the upper left corner of the 3D pixel region 40 in the rendering space 24 is obtained. As described above, the width Ww of the rendering space 24 corresponds to the width of the panel 21, the height Wh of the rendering space 24 corresponds to the height of the panel 21, and the center O of the panel 21 corresponds to the center O of the rendering space 24. Therefore, the vector Dv′ can be obtained by normalizing an X coordinate of the vector Dv by the width of the panel 21, normalizing a Y coordinate of the vector Dv by the height of the panel 21, and then, multiplying the width Ww of the rendering space 24 and the normalized X coordinate and multiplying the height Wh of the rendering space 24 and the normalized Y coordinate.

Next, in the representative ray calculator 121, a terminal position of the representative ray is calculated based on the converted vector Dv′, and a vector of the representative ray is obtained based on the calculated terminal position and the starting position calculated in step S303. Thereby, in the representative ray calculator 121, the representative ray information corresponding to the representative ray number of the selected quantization unit area 42 (step S306). The representative ray information can include the starting position and the terminal position of the representative ray. Furthermore, the starting position and the terminal position may be coordinates in the rendering space 24.

Although the process of step S306 corresponds to a perspective projection, it is not limited to this, and it is also possible to use a parallel projection, for instance. In such case, the vector Dv′ is added to the starting position of the representative ray. Furthermore, it is also possible to combine the parallel projection and the perspective projection. In such case, a component to be perspective-projected among components of the vector Dv′ may be added to the starting position of the representative ray.

After the representative ray information is calculated as described above, then, in the brightness calculator 122, a brightness value of each quantization unit area 42 is calculated based on the representative ray information and the volume data (step S307). As a method of calculating brightness value, it is possible to use a technique such as the ray casting algorithm, the ray tracing algorithm, or the like, described above.

Next, in the sub-pixel brightness generator 123, brightness values of the sub-pixels included in the sub-pixel group corresponding to the selected quantization unit area 42 are decided based on the brightness value of each quantization unit area 42 calculated by the brightness calculator 122 (step S308). A method of deciding brightness value for each sub-pixel may be the same as the above-described method explained using FIG. 7.

After which, the 3D image generator 120 determines whether the above processes have been completed for all the quantization unit areas 42 or not (step S309), and when the processes have not been completed (step S309; NO), the 3D image generator 120 returns to step S310, and repeats the above steps until all the quantization unit areas 42 have been processed. On the other hand, when all the quantization unit areas 42 have been processed (step S309; YES), the 3D image generator 120 returns to the operation shown in FIG. 8.

As described above, according to the first embodiment, as compared to a method of generating a 3D image while interpolating parallax images, it is possible to provide a high-quality 3D image to a user. Furthermore, because processes are not a per-subpixel basis, high-speed processing is possible. Moreover, according to the first embodiment, it is also possible to adjust a balance between image quality and processing speed.

Here, a relationship between calculation amount and a division number in the first embodiment will be explained. As describe above, the 3D pixel region 40 exists more than one. Each 3D pixel region 40 is divided by a predetermined division number. Therefore, the quantization unit area 42 being an actual unit of processing will exist more than one. For example, when there are one hundred 3D pixels and the division number is eight, there are eight hundreds (800=100*8) quantization unit areas 42. In such case, steps S10 to S30 in FIG. 8 may be repeated eight hundreds times. As described above, because the calculation amount in the first embodiment is decided depending on the 3D pixel regions 40 and the division number thereof, but not depending on the number of the sub-pixels of the display device 20, it is possible to adjust the calculation amount arbitrarily. For example, when the display device 20 has ten thousands sub-pixels, generally, the number of rendering may be ten thousands as the number of the sub-pixels. On the other hand, according to the first embodiment, because the number of rendering is one for one quantization unit area 42, it is possible to display a 3D image by eight hundreds renderings with respect to eight hundreds quantization unit areas 42.

In the first embodiment, even if the number of sub-pixels of the display device 20 is increased, only the number of sub-pixels included in each quantization unit area 42 will be increased, and the number of rendering will not be changed. This may produce an advantage such that it is possible to reduce workload for estimating process cost in hardware designing. Furthermore, because processes such as rendering, or the like, are executed independently by quantization unit area 42, it is possible to execute processes for each quantization unit area 42 in parallel, and it is also possible to produce a great effect in speed by executing the processes in parallel.

Because the 3D pixel region 40 is generally decided at a time of designing the optical aperture 23, in practice, the division number should be adjusted. When the division number is small, the interval Td becomes large, and as a result, the number of the quantization unit areas 42 decreases. Therefore, process may be high-speed. However, because each quantization unit area 42 may become large, due to ray numbers included in a broader range being grouped into a single group, there is a possibility such that image quality decays when a view point is shifted within a visible range. That is, in the first embodiment, it is possible to adjust a relationship between process speed and image quality in a view point shift by adjusting the division number. Therefore, it is possible to flexibly adjust the relationship between the process speed and the image quality based on a device of use. For instance, in a low processing power device, the division number may be adjusted so that process speed becomes greater, and in a high processing power device, the division number may be adjusted so that image quality becomes higher, or the like.

Furthermore, in the first embodiment, by adjusting the division number, it is possible to adjust image quality during the view point remains still. Conventionally, in image quality at a certain view point in a 3D display, an image may be blurred due to confusing light rays other than a target light ray, which is called crosstalk. Because a degree of crosstalk is decided by a design of hardware, it is difficult to exclude completely the possibility of crosstalk. However, according to the first embodiment, because vicinally-emitted light rays have the same information by minifying the division number, the confusion of light rays will not be recognized as blurs of image, and as a result, it is possible to improve image quality during the view point remains still. As described above, in the first embodiment, it is an advantage reducing the division number in the high processing power device.

Although the volume data is used as the model data in the first embodiment, it is not limited to the volume data. It is also possible to use another general model in the field of computer graphics such as a boundary representation model, or the like, as the model data, for instance. Also in such case, for the calculation of brightness value, it is possible to use the ray casting algorithm, the ray tracing algorithm, or the like.

In the first embodiment, although the 3D pixel regions 40 are zoned based on the width of each optical element such as a lens, a barrier, or the like, the 3D pixel regions 40 can be zoned based on a total width of two or more optical elements while the two or more optical elements are defined as a single virtual optical element (lens, barrier, or the like). Also in such case, it is possible to execute the same process described above. Furthermore, in step S304, the upper left corner of the 3D pixel region 40 is defined as the reference point 25, whereas it is possible to define any position as long as a point representing the 3D pixel region 40, such as a center obtained by averaging coordinates of an upper left corner and a lower right corner, or the like, as the representative point 25.

Moreover, in the first embodiment, the case where the center O of the panel 21 corresponds to the center O (0, 0) of the rendering space 24 is explained as an example, whereas the center O of the panel 21 can misalign from the center O of the rendering space 24. In such case, by executing appropriate conversion from the coordinate system based on the panel 21 to the coordinate system of the rendering space 24, it is possible to apply the same processes described above. Moreover, in the first embodiment, the case where the width of the panel 21 corresponds to the width Ww of the rendering space 24 and the height of the panel 21 corresponds to the height Wh of the rendering space 24 is explained as an example, whereas at least one of the width and the height of the panel 21 can be different from the width Ww or the height Wh of the rendering space 24. In such case, by converting the coordinate systems of the coordinate system based on the panel 21 and the coordinate system of the rendering space 24 so that sizes in height and width of the panel 21 correspond to sizes in height and width of the rendering space 24, it is possible to apply the same processes described above. Moreover, although the starting position of the representative ray is obtained by the linear interpolation when the ray number includes a digit after the decimal point, an interpolation method is not limited to the linear interpolation, and it is also possible to use another function. For example, the starting position of the representative ray can be obtained by an interpolation using a non-linear function such as the sigmoid function.

### Alternative Example of First Embodiment

As described above, the model data intended in the first embodiment is not limited to the volume data. In an alternative example of the first embodiment, a case where the model data is a combination of a single-viewpoint image (hereinafter to be referred to as a reference image) and depth data corresponding to the single-viewpoint image will be described.

A 3D image display apparatus according to the alternative example may have the same configuration as the 3D image display apparatus 1 shown in FIG. 1. However, in the alternative example, the representative ray calculator 121 and the brightness calculator 122 execute the following operations, respectively.

Representative Ray Calculation Unit

In the alternative example, the representative ray calculator 121 executes the same operations as the operations of steps S301 to S306 shown in FIG. 9. However, the representative ray calculator 121 uses camera positions instead of the reference view points 30. That is, the representative ray calculator 121 calculates a camera position (starting position) of the representative ray using the camera positions of each quantization unit areas, and calculates a distance between the calculated camera position and the center O of the panel 21.

Brightness Calculation Unit

The brightness calculator 122 calculates a brightness value of each sub-pixel from the reference image and the depth data corresponding to each pixel of the reference image based on the distance between the camera position and the center O of the panel 21, which is calculated by the representative ray calculator 121. In the following, an operation of the brightness calculator 122 according to the alternative example will be explained. In the following, as for the sake of shorthand, a case where the reference image is an image corresponds to a ray number ‘0’, the width Ww of the rendering space 24 corresponds to a lateral width of the reference image, the height of the rendering space 24 corresponds to a vertical width (height) of the reference image, and a center of the reference image corresponds to the center O of the rendering space 24, i.e., a case where the panel 21 and the reference image are arranged to the rendering space 24 by the same scale will be explained as an example.

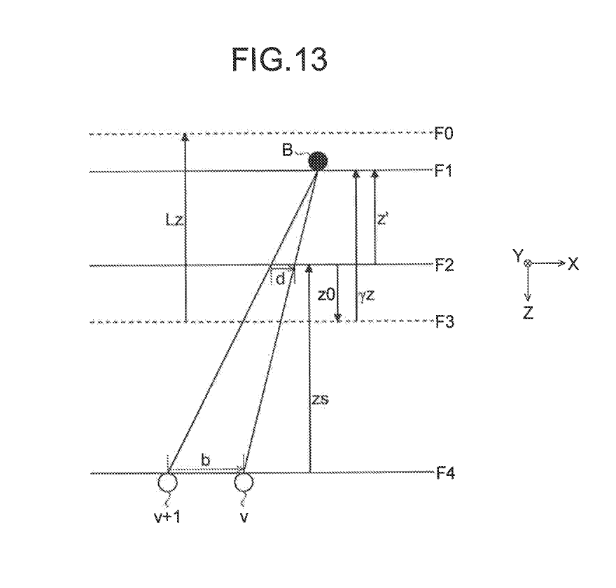

FIG. 13 is an illustration for explaining process of the brightness calculator according to the alternative example. As shown in FIG. 13, in the alternative example, firstly, the brightness calculator 122 obtains a parallax vector d for each pixel (hereinafter to be referred to as reference pixel group) of the reference image. A parallax vector d is a vector indicating which direction and how long a pixel is translated in order to obtain a desired projection amount. A parallax vector d of a certain pixel can be obtained by the following formula (3).

$$γ = \frac{Lz}{{z}_{max}} \\ {z}^{′} = γ {z}_{d} - {z}_{0} \\ d \text{:} b = {z}^{′} \text{:} ( {z}_{s} + {z}^{′} ) \\ d = b ( \frac{{z}^{′}}{{z}_{s} + {z}^{′}} ) \qquad ( 3 )$$

In the formula (3), Lz is a depth size of the rendering space 24, zₘₐₓ is a possible maximum value of depth data, zₒ is a projection distance in the rendering space 24, b is a vector between adjacent camera positions, zₛ is a distance from the camera position to the reference image (panel 21). Furthermore, in FIG. 13, F0 is a position of a plane corresponding to the possible maximum value of the depth data, F1 is a position of an object B in the depth data, F2 is a position of the panel 21, F3 is a position of a plane of a possible minimum value of the depth data, and F4 is a position of a plane where reference view points (v+1, V, . . . ) are arrayed.

Next, the brightness calculator 122 obtains a position vector p′ (x, y) of each pixel in the rendering space 24 after the reference image is translated based on the depth data. A position vector p′ can be obtained by the following formula (4), for instance.

p′(x,y)=p(x,y)+−nᵥd(x,y). (4)

In the formula (4), x and y are a pixel-unitary X coordinate and a pixel-unitary Y coordinate of the reference image, n_{y} is a ray number of a target sub-pixel of which brightness value is to be calculated, p(x, y) is a position vector of each pixel in the rendering space 24 before the reference image is translated, and d(x, y) is a parallax vector d calculated based on depth data corresponding to a pixel with a coordinate (x, y).

After that, the brightness calculator 122 specifies a position vector P′ for letting the position coordinate closest to Dx′ among the obtained position vectors p′ (x, y), and decides a pixel corresponding to the specified position vector P′. A color component corresponding to a sub-pixel of the decided pixel is a target brightness value. When there are two or more pixels for letting the position coordinate closest to Dx′, a pixel with a largest projection amount should be adopted.

In the alternative example, although the parallax vectors d are obtained for every pixels of the reference image, when the camera positions are arrayed along the X axis, for instance, it is also possible to obtain a pixel including an X component Dx′ in the vector Dv′ obtained by the representative ray calculator 121, and obtain the parallax vector d using a pixel having the same Y coordinate as that of the obtained pixel in the coordinate system of the image. On the other hand, when the camera positions is arrayed along the Y axis, it is also possible to obtain a pixel including an Y component Dy′ and obtain the parallax vector d using a pixel having the same X coordinate as that of the obtained pixel in the coordinate system of the image.

When a maximum absolute value |d| of the parallax vector d in the reference image is prospectively known, it is possible to obtain the parallax vector d using pixels included in a region from the X component Dx′ to ±|d|. Furthermore, by combining the above-described methods, it is possible to confine a region for calculating the parallax vector.

As described above, according to the alternative example, even if the model data is the combination of the single-viewpoint image and the depth data corresponding thereto but not a mathematical 3D data, it is possible to generate the 3D image with a minimum interpolation process. Thereby, it is possible to provide a high-quality 3D image to a user.

### Second Embodiment

Next, an image processing device, a 3D image display apparatus, a method of image processing and a program will be explained in detail with accompanying drawings. In the following, as for the same configuration as the first embodiment or the alternative example thereof, the same reference numbers will be applied thereto and redundant explanations thereof will be omitted.

In the second embodiment, a view position of a user is specified, and based on the specified view position, parameters of the panel 21 will be corrected so that the user keeps within a visible range.

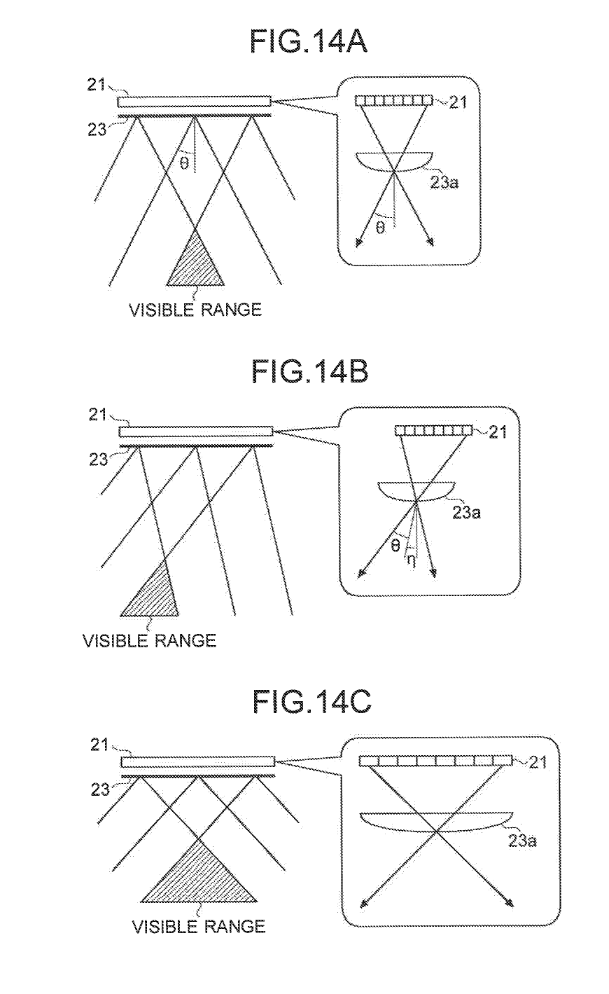

FIGS. 14A to 14C are illustrations showing positional relationships between a panel and optical elements in an optical aperture according to the second embodiment. As shown in FIGS. 14A and 14B, when an optical element 23a in the optical aperture 23 is shifted in the horizontal direction (X direction) from a positional relationship shown in FIG. 14A to a positional relationship shown in FIG. 148, as shown in FIG. 14B, a visible range may be shifted in the shifting direction. In the example shown in FIG. 14B, by shifting the optical aperture 23 leftward along a plane of the paper, a light ray is clockwise-rotated by η from the position in FIG. 14A, and thereby, the visible range is shifted leftward. That is, when the panel 21 and the optical element 23a are physically-misaligned each other, the visible range will not face the front, and shift in any direction. Therefore, in a pixel mapping in the non-patent literature 1, by considering an offset koffset, even if a panel and an optical element are misaligned each other, a visible range can be located in front of the panel. In the second embodiment, by further correcting the physical offset koffset, the visible range will be shifted to the view position of the user. For correcting the physical offset koffset, above-mentioned shifting of the visible range caused by a misalignment between the panel 21 and the optical element 23a is used. The above-mentioned shifting of the visible range caused by the positional relationship between the panel 21 and the optical element 23a can be thought to be similar to oppositely-shifting of the visible range with respect to shift of the panel 21 when considered that a position of the optical element 23a is fixed at an original position. Therefore, by correcting the offset koffset in order to purposely shift the visible range, it is possible to adjust the visible range to the user's view position.

When a width Xn corresponding to a single optical element 23a on the panel 21 is expanded from the position relationship shown in FIG. 14A to a position relationship shown in FIG. 14C, as shown in FIG. 14C, the visible range may come close to the panel 21 (i.e., a width of an elemental image in FIG. 14C is larger than a width of the elemental image in FIG. 14A). Therefore, by correcting the width Xn so that the width Xn becomes greater/smaller than an actual value, it is possible to continuously (finely) correct the position of the visible range in the vertical direction (Z axis direction). Thereby, it is possible to continuously shift the position of the visible range in the vertical direction (Z axis direction), which is only discretely shifted by reshuffling the parallax image in the prior art. Accordingly, it is possible to adjust the visible range appropriately when an observer locates at an arbitrary vertical position (a position in the Z axis direction).

As a result, by correcting the offset koffset and the width Xn appropriately, it is possible to continuously shift the visible range in both directions of the horizontal direction and the vertical direction. Thereby, even if the observer locates at an arbitrary position, it is possible to adjust the visible range to the position of the observer.

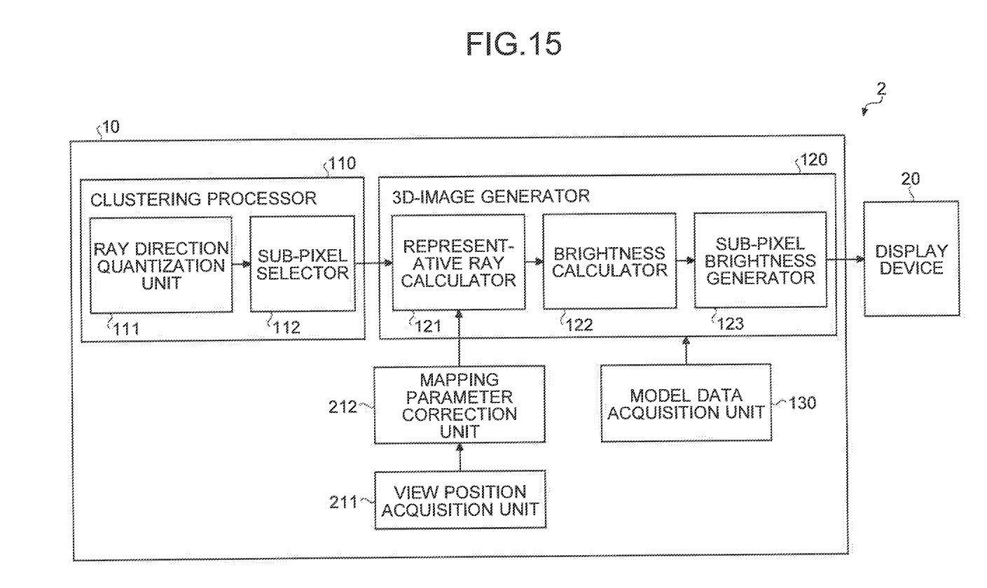

FIG. 15 is a block diagram showing a configuration example of a 3D image display apparatus according to the second embodiment. As shown in FIG. 15, the 3D image display apparatus according to the second embodiment has the same configuration as the 3D image display apparatus shown in FIG. 1, and further has a view position acquisition unit 211 and a mapping parameter correction unit 212.

View Position Acquisition Unit

The view position acquisition unit 211 acquires a user's position in the real space in the visible range as a 3D coordinate value. As the acquisition of the user's position, a device such as a radar, a sensor, or the like, can be used other than an imaging device such as an infrared camera. The view point acquisition unit 211 acquires the user's position from information (picture in a case of using a camera) acquired by such device using the known technique.

For example, when an imaging camera is used, by executing image analysis of image taken by the camera, detection of a user and calculation of a user's position are conducted. Furthermore, when a radar is used, by executing signal processing of inputted signal, detection of a user and calculation of a user's position are conducted.

In the detection of an observer in a human detection/position calculation, an arbitrary target capable of being detected as a person such as a face, a head, whole body of a person, a marker, or the like, can be detected. Furthermore, it is possible to detect positions of eyes of the observer. A method of acquiring a position of a observer is not limited to the above-described methods.

Mapping Parameter Correction Unit

To the mapping parameter correction unit 212, the information about the user acquired by the view position acquisition unit 211 and the panel parameters. The mapping parameter correction unit 212 corrects the panel parameters based on the inputted information about the view position.

Here, a method of correcting the panel parameter using the information about the view position will be explained. In correction of the panel parameters, an offset koffset between the panel 21 and the optical aperture 23 in the X axis direction and a horizontal width Xn of a single optical element constructing the optical aperture 23 on the panel 21 are corrected based on the view position. By such correction, it is possible to shift the visible range according to the 3D image display apparatus 1.

When the method according to the non-patent literature 1 is used for pixel mapping, for instance, by correcting the panel parameter as shown in the following formula (5), it is possible to shift the visible range to a desired position.

koffset=koffset+r_{—}koffset

Xn=r_{—}Xn (5)

In the formula (5), r_koffset represents a correction amount for the offset koffset. A correction amount for the horizontal width Zn is represented as r_Xn. A calculation method of these correction amounts will be described later on.

In the formula (5), although a case where the offset koffset is defined as an offset of the panel 21 with respect to the optical aperture 23 is shown, when the offset koffset is defined as an offset of the optical aperture 23 with respect to the panel 21, the panel parameter is corrected by the following formula (6). In the formula (6), a correction of Xn is the same as the formula (5).

koffset=koffset−r_{—}koffset

Xn=r_{—}^{Xn} (6)

The correction amount r_koffset and the correction amount r_Xn (hereinafter to be referred to as a mapping control parameter) are calculated as the following.

The correction amount r_koffset is calculated from an X coordinate of the view position. Specifically, based on an X coordinate of a current view position, a visual distance L being a distance from the view position to the panel 21 (or the lens), and a gap g being a distance from the optical aperture 23 (a principal point P in a case of using a lens) to the panel 21, the correction amount r_koffset is calculated using the following formula (7). The current view position can be acquired based on information obtained by a CCD camera, an object sensor, an acceleration sensor, or the like, for instance.

$$r\_koffset = \frac{X \times g}{L} \qquad ( 7 )$$

The correction amount r_Xn can be calculated using the following formula (8) based on a Z coordinate of the view position. Here, lens_width is a width of the optical aperture 23 along the X axis direction (the longer direction of the lens).

$$r\_Xn = \frac{Z \times g}{Z} \times lens\_width \qquad ( 8 )$$

3D Image Generator

The 3D image generator 120 calculates a representative ray of each sub-pixel group based on a ray number of each sub-pixel calculated by the ray direction calculator 212 and information about a sub-pixel group using the corrected panel parameters, and executes the same following operation as the first embodiment.

However, as the alternative example of the first embodiment, when the model data is the combination of the reference image and the depth data, the brightness calculator 122 shifts the reference image based on the depth data and the representative ray number, and calculates a brightness value of each sub-pixel group from the sifted reference image.

As described above, in the second embodiment, because the ray number is corrected based on the view position of a user with respect to the panel 21, it is possible to provide a high-quality 3D image to a user locating anywhere.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A 3D image display apparatus capable of displaying a 3D image, the apparatus comprising:
a display having a display panel of which a plurality of sub-pixels are arranged on a surface and an optical aperture opposed to the display panel;
a quantization unit configured to divide the surface of the display panel into areas;
a selector configured to select one or more sub-pixels corresponding to each area to make a sub-pixel group;
a ray calculator configured to calculate a ray number indicating a direction of a representative ray representing rays emitted from each sub-pixel group;
a brightness calculator configured to calculate a brightness value corresponding to each ray number based on the direction of the representative ray and a model data figuring a 3D shape of an object; and
a sub-pixel brightness generator configured to generate the 3D image by determining a brightness value of the sub-pixels included in each sub-pixel group based on the brightness value.

2. The apparatus according to claim 1, wherein
the optical aperture includes a plurality of optical elements arraying along a specific direction, and
the quantization unit zones the surface of the display panel into a plurality of areas based on the array of the plurality of the optical elements, the surface of the display panel having the plurality of sub-pixels being arrayed.

3. The apparatus according to claim 1, wherein the ray calculator calculates an average of ray numbers of the one or more sub-pixels included in each sub-pixel group as the ray number.

4. The apparatus according to claim 1, wherein the model data is a space division model.

5. The apparatus according to claim 1, wherein the model is a boundary representation model.

6. The apparatus according to claim 1, wherein the model data is a combination of depth information of the object included in the model data and a reference image generated for at least one view point.

7. The apparatus according to claim 1, wherein the brightness calculator calculates the brightness values of the sub-pixel groups based on color information of crossing points of the model data and the representative rays.

8. The apparatus according to claim 1, wherein the ray calculator corrects the ray number depending on a coordinate system where the model data is defined.

9. The apparatus according to claim 6, wherein the brightness calculator shifts the reference image based on the depth information of the model data and the ray numbers, and calculates the brightness value of each sub-pixel group based on the shifted reference image.

10. The apparatus according to claim 1, wherein the quantization unit divides the surface of the display panel into areas in accordance with a relation between the surface and the optical aperture.

11. The apparatus according to claim 1, further comprising a ray direction calculator configured to correct the ray number based on a view location of an observer.

12. A method of displaying a 3D image on a display having a display panel of which a plurality of sub-pixels are arranged on a surface and an optical aperture opposite to the display panel, the method including:
dividing the surface of the display panel into areas;
selecting one or more sub-pixels corresponding to each area to make a sub-pixel group;
first calculating a ray number indicating a direction of a representative ray representing rays emitted from each sub-pixel group;
second calculating a brightness value corresponding to each ray number based on the direction of the representative ray and a model data figuring a 3D shape of an object; and
generating the 3D image by determining a brightness value of the sub-pixels included in each sub-pixel group based on the brightness value.

13. An image processing device comprising:
a processor; and
a memory containing a program, the program, when executed, causing the processor to function as:
dividing a surface of a display panel of a display, on which a plurality of sub-pixels are arranged into areas;
selecting one or more sub-pixels corresponding to each area to make a sub-pixel group;
first calculating a ray number indicating a direction of a representative ray representing rays emitted from each sub-pixel group;
second calculating a brightness value corresponding to each ray number based on the direction of the representative ray and a model data figuring a 3D shape of an object; and
generating the 3D image by determining a brightness value of the sub-pixels included in each sub-pixel group based on the brightness value.
